(19) United States
(12) Patent Application Publication
(10) Pub. No.: US 2012/0289093 A1
(43) Pub. Date: Nov. 15, 2012

(54) CONNECTOR

(75) Inventors: Yoshiyuki Ogura, Kanagawa (JP); Yasuyoshi Yoshikai, Kanagawa (JP)

(73) Assignee: IRISO ELECTRONICS CO., LTD., Kanagawa (JP)

(21) Appl. No.: 13/515,711

(22) PCT Filed: Dec. 13, 2010
(86) PCT No.: PCT/JP10/72326

§ 371 Date: Jul. 31, 2012

(30) Foreign Application Priority Data
Dec. 16, 2009 (JP) 2009-285568

(51) Int. Cl. H01R 24/28

(52) U.S. Cl. 439/629

(57) ABSTRACT

A connector is capable of facilitating a rotation manipulation of a pressing member. A pair of first manipulation portions projecting backward from both sides in the width direction are provided on the back ends of the pressing member, and the first manipulation portions are for performing the pressing manipulation in the top-to-bottom direction with a finger upon rotation of the pressing member. The length from the rotation fulcrum of the pressing member to each first manipulation portion (power point) is increasable, and the pressing force for performing the rotation manipulation of the pressing member is reducible. The protrusions projecting upward are on the back end sides of the first manipulation portions. Furthermore, the first manipulation portions are outside in the width direction of the pressing member from the terminals.

### TECHNICAL FIELD

The present invention relates to a connector for connecting, for example, a flexible printed circuit (FPC), a flexible flat cable (FFC), or the like.

### BACKGROUND ART

Conventionally, as a connector of this type, there is known a connector including: a connector body into which an end of an object to be connected (hereinafter referred to as “flexible circuit”), such as an FPC or an FFC, can be inserted on the front surface side; a plurality of terminals disposed in the connector body in the width direction; and a pressing member rotatably provided on the back end side of the connector body, and pressing each of the terminals against the flexible circuit (for example, see Patent Literature 1).

In this connector, when the back end side of the pressing member is pressed downward with a finger and rotated in the state where the flexible circuit is inserted into the connector body, each of the terminals of the pressing member is brought into press contact with the flexible circuit, thereby rendering each of the terminals and the flexible circuit conductive.

### CITATION LIST

### Patent Literature

Patent Literature 1: Japanese Patent Publication 2007-179764

### SUMMARY OF INVENTION

### Technical Problem

Incidentally, in the connector, when the object to be connected having a number of poles, such as an FPC or an FFC, is connected, the number of terminals is also increased by that amount. However, when the number of terminals is increased, a large pressing force is required upon rotation of the pressing member. In addition, since the upper surface on the back end side of the pressing member is formed in a planar shape, a finger slips and the pressing force cannot be reliably transmitted, which leads to a problem of deterioration in the operability of the pressing member.

Thus, if the length from the rotation fulcrum of the pressing member to the back end (power point) of the pressing member is increased, the pressing force for performing a rotation manipulation of the pressing member can be reduced. However, this leads to a drawback that the size on the back side of the pressing member is increased. In particular, since the back end of each terminal is soldered to a substrate, there is a need to check the connection state by visually observing the back end of each terminal from above upon mounting onto the substrate. In this case, however, when the length on the back side of the pressing member is increased, the back end of each terminal hides behind the pressing member, which makes it difficult to visually observe the back end of each terminal from above. This leads to a problem of interfering with an operation of checking the connection state.

The present invention has been made in view of the above-mentioned problems, and it is an object of the present invention to provide a connector capable of facilitating a rotation manipulation of a pressing member without increasing the size of the pressing member on the central side thereof in the width direction.

### Solution to Problem

To achieve the above-mentioned object, there is provided a connector including: a connector body into which an object to be connected is inserted from a front side; a plurality of terminals held by the connector body at intervals in a width direction; and a pressing member rotatably provided on a back end side of the connector body, and pressing each of the terminals against the object to be connected through a rotation in a predetermined direction. The connector includes a pair of manipulation portions provided on back ends of the pressing member to project backward from both sides in a width direction of the pressing member, and capable of performing a pressing manipulation in a top-to-bottom direction with a finger upon rotation of the pressing member, and each of the manipulation portions is provided with a protrusion projecting upward on the back end side of each of the manipulation portions and disposed outside the pressing member in the width direction with respect to each of the terminals.

With this configuration, upon rotation of the pressing member, each manipulation portion of the pressing member is pressed downward with a finger, thereby facilitating the rotation of the pressing member. That is, since each manipulation portion projects toward the back side of the pressing member, the length from the rotation fulcrum of the pressing member to each manipulation portion (power point) is increased, so that the pressing force for performing a rotation manipulation of the pressing member is reduced. In this case, the protrusion projecting upward is provided on the back end side of each manipulation portion, thereby allowing the pressing force to be reliably transmitted with the protrusion as a slip resistance. Further, the manipulation portions are provided on both sides of the pressing member in the width direction, thereby preventing an increase in the size of the central portion of the pressing member in the width direction toward the back side.

### Advantageous Effects of Invention

According to the present invention, the length from the rotation fulcrum of the pressing member to each manipulation portion (power point) can be increased, thereby making it possible to reduce the pressing force for performing the rotation manipulation of the pressing member with a finger, and facilitating the manipulation of the pressing member. In this case, the pressing force can be reliably transmitted with the protrusion of each manipulation portion as a slip resistance. This results in improvement of the operability. Further, the size of the central portion of the pressing member in the width direction is prevented from being increased toward the back side. This allows visual observation of the back end side of each terminal from above through the recess formed between the manipulation portions on the both sides in the width direction. When the soldered state is checked by visually observing the back end side of each terminal from above upon mounting onto the substrate, the operation of checking the connection state can be facilitated. Furthermore, upon rotation of the pressing member, the back end side of each terminal can be received in the recess formed between the manipulation portions. This makes it possible to sufficiently secure the amount of rotation of the pressing member 30 without hindering the rotation of the pressing member due to an interference between each manipulation portion and the back end side of each terminal.

### BRIEF DESCRIPTION OF DRAWINGS

FIG. 1 is a front surface side perspective view of a connector in a closed state showing an embodiment of the present invention.

FIG. 2 is a back surface side perspective view of the connector in the closed state.

FIG. 3 is a front surface side perspective view of the connector in an open state.

FIG. 4 is a back surface side perspective view of the connector in the open state.

FIG. 5 is a plan view of the connector in the closed state.

FIG. 6 is a plan view of the connector in the open state.

FIG. 7 is a side sectional view showing a closing operation of the connector.

FIG. 8 is a side sectional view showing an opening operation of the connector using a first manipulation portion.

FIG. 9 is a side sectional view showing the opening operation of the connector using a second manipulation portion.

### DESCRIPTION OF EMBODIMENTS

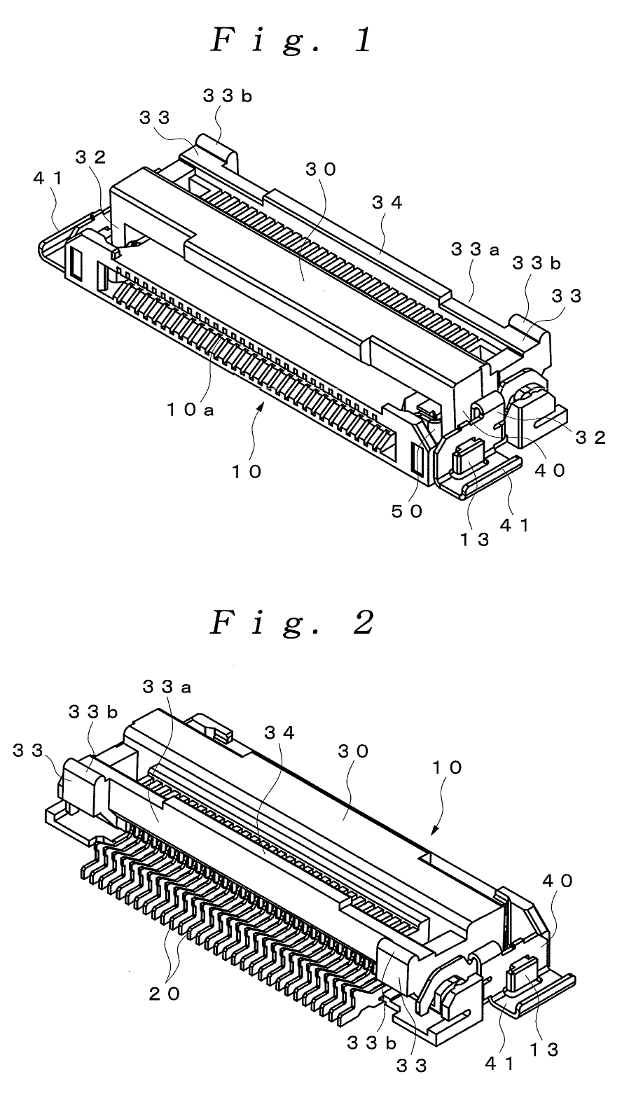

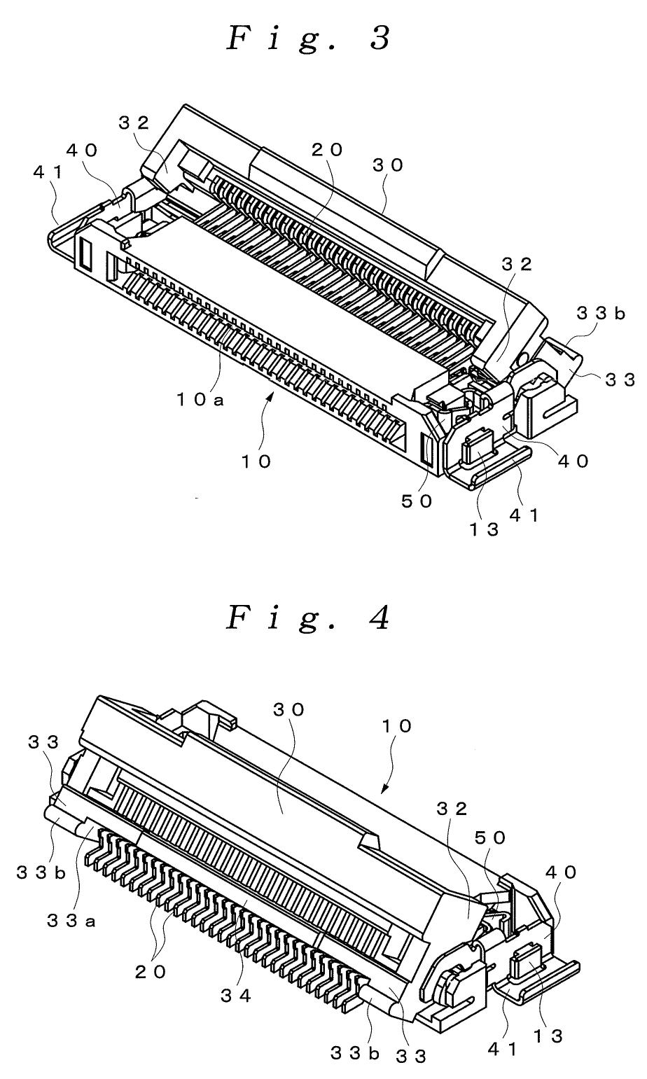

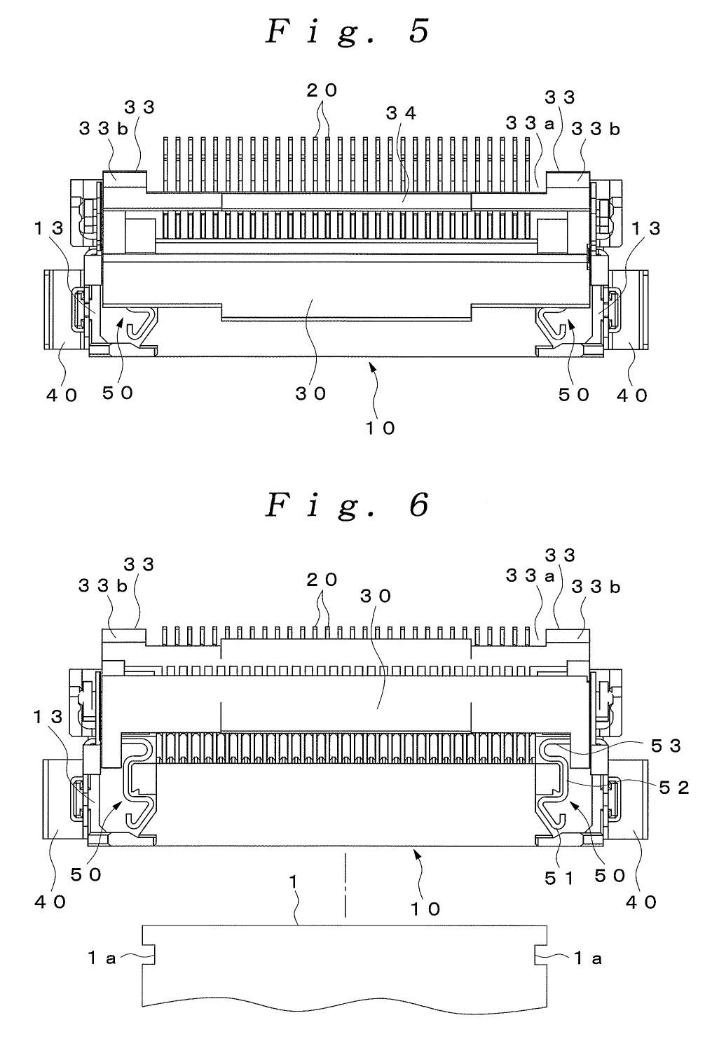

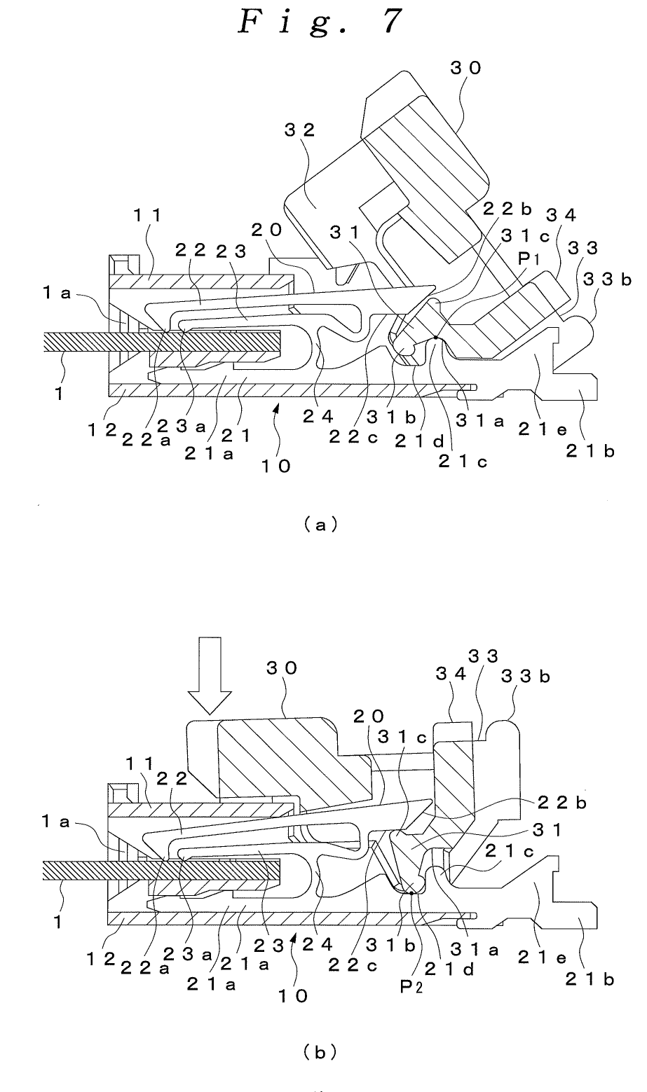

FIGS. 1 to 9 show an embodiment of the present invention. A connector shown in the figures includes a connector body 10 into which a flexible circuit 1 serving as an object to be connected is inserted from the front side; a plurality of terminals 20 disposed in the connector body 10 at intervals in the width direction; a rotatable pressing member 30 for pressing each terminal 20 against the flexible circuit 1 inserted into the connector body 10; a pair of right and left fixing members 40 for fixing the connector body 10 to a substrate which is not shown; and a pair of right and left lock members 50 to engage with the flexible circuit 1.

The flexible circuit 1 is composed of a so-called flexible flat cable (FFC) or flexible printed circuit (FPC), and the upper surface on the leading end thereof is provided with a plurality of electric contacts (not shown) disposed at intervals in the width direction. Further, notches 1a to engage with the lock members 50 are provided on both ends of the flexible circuit 1 in the width direction. When the flexible circuit 1 is inserted to a predetermined position (a position connecting with each terminal 20) of the connector body 10, the lock members 50 engage with the respective notches 1a.

The connector body 10 is formed of a molding made of synthetic resin, and an insertion port 10a into which the flexible circuit 1 is inserted is provided on the front surface of the connector body 10. The connector body 10 is composed of an upper surface portion 11, a bottom surface portion 12, and right and left side surface portions 13. The upper surface portion 11 is formed only on the upper surface front end side of the connector body 10. Further, the right and left sides of the upper surface portion 11 are open to expose the connector body 10, and the lock members 50 are disposed in the open portion.

The terminals 20 are each formed of a conductive metal plate, and are held by the bottom surface portion 12 of the connector body 10 at intervals in the width direction. Each terminal 20 includes a fixed piece 21 to be fixed to the bottom surface portion 12; a first movable piece 22 to be pressed by the pressing member 30; a second movable piece 23 disposed below the first movable piece 22; and an elastic piece 24 formed between the second movable piece 23 and the fixed piece 21.

The fixed piece 21 is formed to extend in the front-back direction of the connector body 10, and a front end portion 21a of the fixed piece 21 is press-fit into a gap on the side of the bottom surface portion 12. A connection portion 21b connecting to the substrate, which is not shown, is provided on the back end of the fixed piece 21. The connecting portion 21b is formed to extend out to the back side of the connector body 10. A first protrusion 21c with which the pressing member 30 rotatably engages is provided on the back end side of the fixed piece 21. A first recess 21d is provided on the front side of the first protrusion 21c. Further, a rotation regulating portion 21e against which the back end side of the pressing member 30, which rotates downward, abuts is provided on the back end side of the fixed piece 21. The rotation regulating portion 21e projects upward, and the front end side thereof is formed to be inclined downward toward the front side.

The first movable piece 22 is formed to extend in the front-back direction of the connector body 10, and the front end thereof is provided such that a first contact portion 22a in contact with the upper surface of the flexible circuit 1 projects downward. A first abutting portion 22b and a second abutting portion 22c, against which the pressing member 30 abuts, are provided on the back end of the first movable piece 22. The first abutting portion 22b is formed to be inclined forward in the top-to-bottom direction on the back end surface of the first movable piece 22. The second abutting portion 22c is formed to be substantially horizontally along the front-back direction on the lower end surface of the first movable piece 22.

The second movable piece 23 is formed to extend in the front-back direction of the connector body 10, and the front end thereof is provided such that a second contact portion 23a in contact with the upper surface of the flexible circuit 1 projects downward. In this case, the second movable piece 23 is formed to be shorter than the first movable piece 22 in the front-back direction of the connector body 10. Further, the second contact portion 23a is positioned on the back side of the first contact portion 22a, and is formed at the same height position as the lower end (contact) position thereof. The back end side of the second movable piece 23 is formed to extend to the back end side (front side of the second butting portion 22c) of the first movable piece 22, and the first movable piece 22 is supported by the back end side of the second movable piece 23.

The elastic piece 24 is formed to extend in the vertical direction from the substantial center in the front-back direction of the fixed piece 21 to the substantial center in the front-back direction of the second movable piece 23, and the first movable piece 22 and the second movable piece 23 are supported in such a manner that each of the front end side and the back end side thereof is displaced in the vertical direction.

The pressing member 30 is formed of a molding made of synthetic resin, and is formed to cover the upper surface back end side of the connector body 10. A rotation support portion 31 that projects toward the inside of the connector body 10 is provided on the back end side of the pressing member 30. A second recess 31a that engages with the first protrusion 21c of the terminal 20 is provided on the tip end side of the rotation support portion 31. A second protrusion 31b that engages with the first recess 21d of the terminal 20 is provided on the front side of the second recess 31a. That is, when the second recess 31a engages with the first protrusion 21c, the pressing member 30 is rotated with the contact portion between the second recess 31a and the first protrusion 21c as a fulcrum. When the second protrusion 31b engages with the first recess 21d, the pressing member 30 is rotated with the contact portion between the second protrusion 31b and the first recess 21d as a fulcrum. In this case, the rotation fulcrum is positioned between the front end side of the back end side of the pressing member 30. When the front end side of the pressing member 30 is pressed downward, the back end side ascends and the pressing member 30 comes into the closed state. When the back end side of the pressing member 30 is pressed downward, the front end side ascends and the pressing member 30 comes into the open state. The rotation support portion 31 is provided with a pressing portion 31c that abuts against each of the first abutting portion 22b and the second abutting portion 22c of the terminal 20, and the pressing portion 31c is formed to project in a mountain shape. Projecting portions 32 that regulate displacement in the width direction of the lock members 50 are provided on both sides of the pressing member 30 in the width direction. Each of the projecting portions 32 is formed to project downward.

Further, a pair of first manipulation portion 33 capable of performing a pressing manipulation in the top-to-bottom direction with a finger upon rotation of the pressing member 30 is provided on the back ends of the pressing member 30. Each of the first manipulation portions 33 is formed to project backward from the both sides of the pressing member 30 in the width direction. In this case, the pressing member 30 is formed so as to allow the back end side (connecting portion 21b) of each terminal 20 to be visually observed from above through a recess 33a formed between the first manipulation portions 33, and is formed to be able to receive the back end sides (connecting portion 21b and rotation regulating portion 21e) of the terminals 20 within the recess 33a upon downward rotation of the back end side of the pressing member 30. Protrusions 33b that project upward are provided on the back end sides of the first manipulation portions 33. The protrusions 33b are formed to extend in the width direction of the first manipulation portions 33. Further, a second manipulation portion 34 capable of performing a pressing manipulation in the top-to-bottom direction using a pressing instrument A upon rotation of the pressing member 30 is provided on the back end of the pressing member 30. The second manipulation portion 34 is formed to project upward on the center side of the pressing member 30 in the width direction. In this case, the second manipulation portion 34 is provided to be positioned between the first manipulation portions 33, and the length thereof in the width direction is formed to be slightly longer than the width in the width direction of the recess 33a.

The fixing members 40 are formed of metal plates disposed on both sides of the connector body 10 in the width direction, and are fixed to the side surface portions 13 of the connector body 10. Connecting portions 41 to be connected to the substrate, which is not shown, are provided on the lower ends of the fixing members 40. The connecting portions 41 are formed to extend toward the outside of the connector body 10 in the width direction.

The lock members 50 are formed of metal plates integrally formed with the fixing members 40, and are disposed on the both sides of the connector body 10 in the width direction. Each lock member 50 includes an engagement portion 51 that engages with the corresponding notch la of the flexible circuit 1; a movable portion 52 that extends backward from the engagement portion 51; and an elastic portion 53 that extends from the back end of the movable portion 52 to the corresponding fixing member 40. The engagement portion 51 and the movable portion 52 are displaced in the width direction of the connector body 10 due to elastic deformation of the elastic portion 53. The engagement portion 51 is formed in a mountain shape to project inward from the movable portion 52 in the width direction of the connector body 10. The movable portion 52 is formed to linearly extend in the front-back direction of the connector body 10. The elastic portion 53 extends toward the inside in the width direction of the connector body 10 from the back end of the movable portion 52, and is bent so as to extend to the corresponding fixing member 40 toward the outside in the width direction of the connector body 10. Due to elastic deformation of the connector body 10 in the front-back direction, the engagement portion 51 and the movable portion 52 are displaced in the width direction of the connector body 10. In this case, between the side surface portions 13 of the movable portion 52 and the connector body 10 in the state where they are not displaced, a gap in which the projecting portions 32 of the pressing member 30 can be inserted is formed. In the state where the movable portion 52 is displaced to the outside in the width direction of the connector body 10, the projecting portion 32 abuts against the movable portion 52, thereby regulating the insertion into the gap.

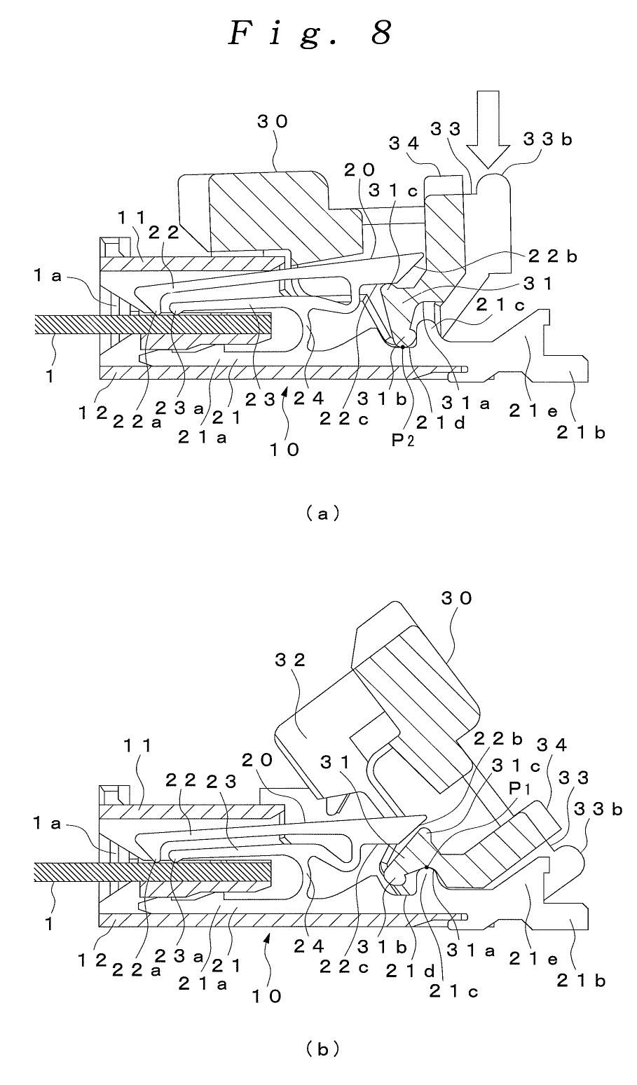

In the connector structured as described above, as shown in FIG. 7(a), the pressing member 30 is brought into the open state to allow the flexible circuit 1 to be inserted into the connector body 10 from the insertion port 10a. Further, when the front end side of the pressing member 30 is pressed downward, the second recess 31a of the pressing member 30 is rotated while engaging with the first protrusion 21c with the contact portion between the second recess 31a and the first protrusion 21c as a rotation fulcrum P1, and the pressing portion 31c of the pressing member 30 abuts against the first abutting portion 22b of the first movable piece 22 toward the front side. In this case, since the first abutting portion 22b is inclined downward toward the front side, the back end side of the first movable piece 22 is pressed upward by the pressing portion 31c and the front end side thereof is lowered. Along with this, the back end side of the second movable piece 23 is also pressed upward and the front end side thereof is lowered. As a result, the first contact portion 22a and the second contact portion 23a are brought into press contact with the upper surface of the flexible circuit 1, and the movable pieces 22 and 23 are rendered conductive with the flexible circuit 1. Then, when the front end side of the pressing member 30 is further pressed downward, as shown in FIG. 7(b), the second protrusion 31b engages with the first recess 21d. At the same time, the second recess 31a is apart from first protrusion 21c, and the pressing member 30 is rotated with the contact portion between the second protrusion 31b and the first recess 21d as a second rotation fulcrum P2. Thus, the rotation fulcrum of the pressing member 30 shifts to the second rotation fulcrum P2 which has a longer distance from the pressing portion 31c than that of the first rotation fulcrum P1. Accordingly, the pressing force of the pressing member 30 is increased and the back end side of the first movable piece 22 is further pressed upward. In this case, since the abutting position of the pressing portion 31c shifts to the substantially horizontal second abutting portion 22c from the first abutting portion 22b, the abutting state between the pressing portion 31c and the second abutting portion 22c allows the movable pieces 22 and 23 to be held in the displaced state and regulates the rotation of the pressing member 30 in the open direction. Further, due to a change in angle of each of the abutting portions 22b and 22c, such an operational feeling that the pressing member 30 is closed is obtained upon shifting of the abutting position of the pressing portion 31c.

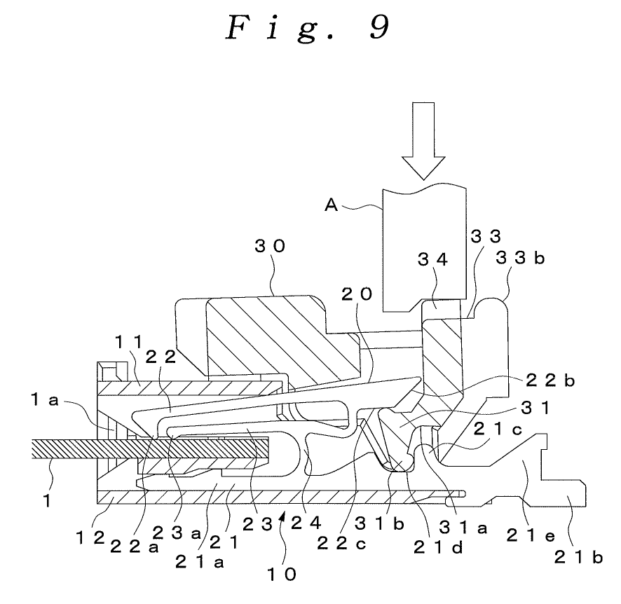

Next, as shown in FIG. 8(a), when the back end side of the pressing member 30 is pressed downward, the second recess 31a of the pressing member 30 engages with the first protrusion 21c, and the pressing member 30 is rotated about the first rotation fulcrum P1, so that the front end side of the pressing member 30 ascends. In this case, the abutting position of the pressing portion 31c shifts from the second abutting portion 22c to the first abutting portion 22b. Then, when the back end side of the pressing member 30 is further pressed downward, as shown in FIG. 8(b), the pressing member 30 is rotated to the open position, and the abutting state between the pressing portion 31c and the first abutting portion 22b is released. As a result, due to the restoring force of the elastic piece 24, the movable pieces 22 and 23 are displaced to raise the front end side, and the contact portions 22a and 23a are apart from the flexible circuit 1 to release the contact state. This allows the flexible circuit 1 to be removed from the connector body 10.

In the case of rotating the pressing member 30 in the open direction, the first manipulation portions 33 of the pressing member 30 are pressed downward with a finger, thereby facilitating the rotation of the pressing member 30. That is, since each of the first manipulation portions 33 projects toward the back side of the pressing member 30, the length from the rotation fulcrum of the pressing member 30 to each first manipulation portion 33 (power point) is increased, with the result that the pressing force for performing the rotation manipulation of the pressing member 30 is reduced. In this case, when the pressing member 30 is rotated, the upper surface of each first manipulation portion 33 is inclined downward toward the back side of the upper surface. However, since the protrusions 33b that project upward are provided on the back end sides of the first manipulation portions 33, the pressing force is reliably transmitted with each protrusion 33b as a slip resistance. Further, the first manipulation portions 33 are provided on the both sides of the pressing member 30 in the width direction. This allows visual observation of the back end side (connecting portion 21b) of each terminal 20 from above through the recess 33a formed between the first manipulation portions 33, without increasing the size on the center side in the width direction of the pressing member 30 toward the back side. Moreover, upon downward rotation of the back end side of the pressing member 30, the back end sides (connecting portion 21b and rotation regulating portion 21e) of the terminals 20 within the recess 33a can be received.

Further, in the case of rotating the pressing member 30 in the open direction, when it is difficult to perform the pressing manipulation of the pressing member 30 with a finger due to the presence of a peripheral part, for example, the second manipulation portion 34 of the pressing member 30 is pressed downward using the pressing instrument A as shown in FIG. 9, thereby facilitating the rotation of the pressing member 30. In this case, the lower surface of the pressing instrument A has a step formed such that the front end side becomes lower than the back end side. In the case of pressing the second manipulation portion 34 on the back end side of the lower surface of the pressing instrument A, the pressing force of the pressing instrument A is reliably applied to the second manipulation portion 34 without displacement in position of the pressing instrument A in the back side direction due to the steps engaging with the second manipulation portion 34. Further, since the second manipulation portion 34 is provided on the center side in the width direction of the pressing member 30, the second manipulation portion 34 can be pressed even when the width dimension of the pressing instrument A is small. Note that the length from the rotation fulcrum of the pressing member 30 to the second manipulation portion 34 (power point) is shorter than the length to each first manipulation portion 33. However, in the case of using the pressing instrument A, a larger force can be applied as compared to the case of direct pressing with a finger, thereby facilitating the rotation of the pressing member 30.

Thus, according to the connector of this embodiment, the rotation fulcrums P1 and P2 of the pressing member 30 are provided between the front end side of the back end side of the pressing member 30; each terminal 20 is pressed against the flexible circuit 1 by the pressing member 30 when the front end side of the pressing member 30 is pressed to be rotated in one direction; and the pressing of each terminal 20 by the pressing member 30 is released when the back end side of the pressing member 30 is pressed to be rotated in the other direction. This allows the pressing member 30 to be rotated by the pressing manipulation also when the pressing member 30 is rotated in any direction, thereby improving the operability of the pressing member 30. In this case, there is no need to perform the manipulation of raising the pressing member with a finger, unlike the conventional case. Accordingly, there is no need to increase the size in the height direction of the connector itself to improve the operability, which is extremely advantageous for mounting onto a small electronic device.

Further, the pair of first manipulation portions 33 projecting backward from the both sides in the width direction of the pressing member 30 is provided on the back ends of the pressing member 30, and the first manipulation portions 33 are allowed to perform the pressing manipulation in the top-to-bottom direction with a finger upon rotation of the pressing member 30. This enables an increase in the length from the rotation fulcrum of the pressing member 30 to each first manipulation portion 33 (power point), and enables a reduction in the pressing force for performing the rotation manipulation of the pressing member 30. In this case, the protrusions 33b projecting upward are provided on the back end sides of the first manipulation portions 33. Accordingly, upon rotation of the pressing member 30, even when the upper surface of each first manipulation portion 33 is inclined downward toward the back side, the pressing force can be reliably transmitted with each protrusion 33b as a slip resistance, thereby improving the operability. Furthermore, the first manipulation portions 33 are disposed outside in the width direction of the pressing member 30 from the terminals 20. This allows visual observation of the back end side (connecting portion 21b) of each terminal 20 from above through the recess 33a formed between the first manipulation portions 33, without increasing the size on the center side in the width direction of the pressing member 30. Moreover, when the back end side of the pressing member 30 is rotated downward, the back end sides (connecting portion 21b and rotation regulating portion 21e) of the terminals 20 can be received within the recess 33a.

Further, the second manipulation portion 34 projecting upward from the center side in the width direction of the pressing member 30 is provided on the back end of the pressing member 30, and the pressing manipulation is performed in the top-to-bottom direction using the pressing instrument A upon rotation of the pressing member 30. Accordingly, the pressing member 30 can be easily rotated by pressing the second manipulation portion 34 downward using the pressing instrument A, even when the pressing manipulation of the pressing member 30 is hardly performed with a finger due to the presence of a peripheral part, for example. This is extremely advantageous for the rotation manipulation of the pressing member 30 after mounting onto the substrate. In this case, the second manipulation portion 34 is provided on the center side in the width direction of the pressing member 30. This enables pressing of the second manipulation portion 34 even when the width dimension of the pressing instrument A is small. For example, a general-purpose tool such as a driver may also be used as the pressing instrument.

Further, the pressing member 30 is formed such that the back end side (connecting portion 21b) of each terminal 20 can be visually observed from above through the recess 33a formed between the first manipulation portions 33. This facilitates the operation of checking the connection state while preventing the back end side of each terminal 20 from hiding behind the pressing member 30, in the case of checking the soldered state by visually observing the back end side of each terminal 20 from above upon mounting onto the substrate.

Furthermore, the pressing member 30 is formed such that when the back end side of the pressing member 30 is rotated downward, the back end sides (connecting portion 21b and rotation regulating portion 21e) of the terminals 20 can be received within the recess 33a formed between the first manipulation portions 33. Consequently, the amount of rotation of the pressing member 30 can be sufficiently secured without inhibiting the rotation of the pressing member 30 due to an interference between each first manipulation portion 33 and the back end side of each terminal 20.

### REFERENCE SIGNS LIST

1 FLEXIBLE CIRCUIT
20 TERMINAL
30 PRESSING MEMBER
33 FIRST MANIPULATION PORTION
33a RECESS
33b PROTRUSION
34 SECOND MANIPULATION PORTION

1. A connector including: a connector body into which an object to be connected is inserted from a front side; a plurality of terminals held by the connector body at intervals in a width direction; and a pressing member rotatably provided at a back end side of the connector body, and bringing each of the terminals and the object to be connected into press contact with each other through a rotation in a predetermined direction, the connector comprising:
a pair of manipulation portions provided on back ends of the pressing member to project backward from both sides in the width direction of the pressing member, and capable of performing a pressing manipulation in a top-to-bottom direction with a finger upon rotation of the pressing member,
wherein each of the manipulation portions is disposed outside the pressing member in the width direction from each of the terminals, and
wherein a back end side of each of the manipulation portions is provided with a protrusion projecting upward.

2. The connector according to claim 1, further comprising another manipulation portion provided to project upward from a center side in the width direction of the pressing member on the back end of the pressing member, and capable of performing a pressing manipulation in the top-to-bottom direction using an arbitrary pressing instrument upon rotation of the pressing member.

3. The connector according to claim 1, wherein the pressing member includes a recess formed between the manipulation portions provided on the both sides in the width direction of the pressing member, and allowing a back end side of each of the terminals extending backward of the connector body to be visually observed from above through the recess.

4. The connector according to claim 1, wherein the pressing member includes a recess formed between the manipulation portions provided on the both sides in the width direction of the pressing member, and allowing a back end side of each of the terminals extending backward of the connector body to be received upon downward rotation of the back end side of the pressing member.
